(19) United States
(12) Patent Application Publication
(10) Pub. No.: US 2024/0145675 A1
(43) Pub. Date: May 2, 2024

(54) MULTI-ELECTRODE

(71) Applicants: Fábio Plut FERNANDES, Matäo (BR); Carlos Alberto Alves CAIRO, São José dos Campos (BR)

(72) Inventors: Fábio Plut FERNANDES, Matäo (BR); Carlos Alberto Alves CAIRO, São José dos Campos (BR)

(21) Appl. No.: 18/496,125

(22) Filed: Oct. 27, 2023

Related U.S. Application Data
(60) Provisional application No. 63/381,597, filed on Oct. 31, 2022.

(51) Int. Cl. H01M 4/36; H01M 4/131; H01M 4/133

(52) U.S. Cl. CPC H01M 4/362; H01M 4/131; H01M 4/133

(57) ABSTRACT

A multi-electrode having a first electrode material and a second electrode material, the first electrode material being functionable by a first electrochemical mechanism, and the second electrode material being functionable by a second electrochemical mechanism that is different from the first electrochemical mechanism.

### CROSS-REFERENCE TO RELATED APPLICATIONS

This application claims priority to U.S. Provisional Application No. 63/381,597, filed on Oct. 31, 2022, the contents of which are expressly incorporated herein in their entirety.

### TECHNICAL FIELD

The present disclosure is directed to a multi-electrode and electrochemical systems having the same.

### BACKGROUND

Secondary batteries have developed over recent years into a more cost-efficient and environmentally friendly alternative to disposable batteries. Materials for such electrochemical systems is thus a present need.

### SUMMARY

The present disclosure is directed to a multi-electrode having a first electrode material and a second electrode material, the first electrode material functionable by a first electrochemical mechanism, and the second electrode material functionable by a second electrochemical mechanism that is different from the first electrochemical mechanism. According to some aspects, the first electrode material may include a metallic material, a metal oxide material, or a combination thereof. According to some aspects, the second electrode material may include a carbon material, a transition metal dichalcogenide, a metal oxide, and/or a polymers conductor. According to some aspects, the second electrode material may include a single-layer material.

The present disclosure is also directed to an electrochemical system having at least one multi-electrode as described herein. The electrochemical system may further include an electrolyte having a first electrolyte component and a second electrolyte component, wherein the first and second electrolyte components are reactive with the first and second electrode materials, respectively.

### BRIEF DESCRIPTION OF THE DRAWINGS

FIG. 1A shows an electron microscopy image of a first view of a first example composite according to aspects of the present disclosure.

FIG. 1B shows an electron microscopy image of a second view of a first example composite according to aspects of the present disclosure.

FIG. 1C shows an electron microscopy image of a third view of a first example composite according to aspects of the present disclosure.

FIG. 2A shows an electron microscopy image of a first view of a second example composite according to aspects of the present disclosure.

FIG. 2B shows an electron microscopy image of a second view of a second example composite according to aspects of the present disclosure.

FIG. 2C shows an electron microscopy image of a third view of a second example composite according to aspects of the present disclosure.

FIG. 3 shows the capacitance of the electrodes described in Example I.

FIG. 4 shows a battery cycling curve for the electrodes described in Example II.

FIG. 5 shows the capacitance of the electrodes described in Example III.

FIG. 6 shows an example discharge and charge process of an electrochemical system having a multi-electrode as described herein.

FIG. 7 shows a scanning electron microscopy image of the TiO₂@Gr composite described in Example IV(a).

FIG. 8 shows a scanning electron microscopy image of the TiO₂@Gr multi-electrode described in Example IV(b).

FIG. 9A shows the potential behavior during discharge of the electrochemical system described in Example IV(c).

FIG. 9B shows the potential behavior during charge of the electrochemical system described in Example IV(c).

FIG. 10A shows the galvanostatic discharge of the multi-electrode described in Example IV(c).

FIG. 10B shows the cycling charge and discharge of the multi-electrode described in Example IV(c).

FIG. 11A shows the potential behavior during discharge of the electrochemical system described in Example IV(d).

FIG. 11B shows the charge process of the electrochemical system described in Example IV(d).

FIG. 12A shows the galvanostatic discharge of the electrochemical system described in Example IV(d).

FIG. 12B shows the cycling charge and discharge of the electrochemical system described in Example IV(d).

FIG. 13 shows the behavior of the voltage as a function of time as described in Example V(b).

FIG. 14A shows the potential behavior for each of the ten charge and discharge cycles as described in Example V(c).

FIG. 14B shows the potential for each of the ten charge and discharge cycles as described in Example V(c).

FIG. 14C shows the behavior of the charges involved in each of the plateaus as described in Example V(c).

FIG. 14D shows the potential behavior as a function of time as described in Example V(c).

FIG. 14E shows the behavior of the charges over the ten cycles described in Example V(c).

FIG. 15A shows the potential as a function of time as described in Example V(d).

FIG. 15B shows the charges of plateaus represented as a function of the cycle number over the first ten cycles as described in Example V(d).

FIG. 16A shows the potential behavior over time for each of the ten cycles as described in Example V(e).

FIG. 16B shows the values of the charges associated with each plateau of the first ten cycles as described in Example V(e).

FIG. 17A shows the potential behavior over time for each of the ten cycles as described in Example V(f).

FIG. 17B shows the behavior of the loads involved in each plateau as a function of the number of cycles as described in Example V(f).

FIG. 18 shows results obtained from the charge and discharge procedures as described in Examples V(c)-(f).

### DETAILED DESCRIPTION

The present disclosure is directed to a multi-electrode having a first electrode material and a second electrode material, the first electrode material functionable by a first electrochemical mechanism, and the second electrode material functionable by a second electrochemical mechanism that is different from the first electrochemical mechanism. According to some aspects, the first electrode material may include a metallic material, a metal oxide material, or a combination thereof, and/or the second electrode material may include a carbon material, a transition metal dichalcogenide, a metal oxide, a polymers conductor, or a combination thereof. According to some aspects, the second electrode material may include a single-layer material. In some examples, the first electrode material and the second electrode material may be provided as a composite material.

The present disclosure is also directed to an electrochemical system having at least one multi-electrode as described herein. The electrochemical system may further include an electrolyte having a first electrolyte component and a second electrolyte component, wherein the first and second electrolyte components are reactive with the first and second electrode materials, respectively.

As used herein, the term “electrochemical mechanism” refers to a chemical reaction resulting in electron transfer. In some aspects, the electrochemical mechanism may include a half-reaction, that is, an oxidation or reduction reaction.

The multi-electrode of the present disclosure includes a first electrode material functionable by a first electrochemical mechanism. That is, the first electrode material of the present disclosure functions in an electrochemical system via a first electrochemical mechanism as described herein. In some aspects, the first electrochemical mechanism may be described by equation (1):

M+A^{x-}⇄MA+xe− (1)

In equation (1), M is the first electrode material, A is an anionic electrolyte component, and e− are electrons.

According to some aspects, the first electrode material may include a metallic material and/or a metal oxide material that reacts with an anionic electrolyte component during discharge of an electrochemical system. In one non-limiting example, the metallic material may include a lead material. In this example, when the multi-electrode is provided in contact with an anion in an electrolyte, such as SO₄²⁻, the first electrochemical mechanism may include a reaction as shown below as equation (2a):

Pb+SO₄²⁻→PbSO₄+2e− (2a)

It should be understood that equation (2a) represents a first discharge mechanism, that is, the first electrochemical mechanism observed upon discharge of an electrochemical system that includes the multi-electrode. In this example, during charge of the electrochemical system, the multi-electrode may be functionable by a first charge mechanism, that is, the first electrochemical mechanism observed upon charge of an electrochemical system that includes the multi-electrode. The first charge mechanism may include a reaction as shown below as equation (2b):

PbSO₄+2e−→Pb+SO₄²⁻ (2b)

It should also be understood that the present disclosure is not limited to this example. In particular, the first electrode material may include any metal, metal oxide, alloy thereof, and/or hydride thereof useful in a multi-electrode as described herein. Non-limiting examples include lead, lead oxides, iron, nickel, cadmium, aluminum, zinc, titanium, nickel metal hydrides, and combinations thereof.

For example, equation (2c) shows an example of a first discharge mechanism corresponding with a multi-electrode having a metallic material that includes titanium:

Ti+H₂O→TiO+2H⁺+2e− (2c)

Equation (2d) shows an example of a first charge mechanism corresponding with a multi-electrode having a metallic material that includes titanium:

TiO+2H⁺+2−→Ti+H₂O (2d)

According to some aspects, the first electrochemical mechanism may additionally include the formation and/or elimination of passivating films at the interface of the first electrode material and an electrolyte, as known in the art.

It should be understood that while the above examples include an electrolyte having SO₄²⁻, the electrochemical system of the present disclosure are not limited in this way. In particular, the electrolyte may include any first electrolyte component that is reactive with the first electrode material as described herein. According to some aspects, the first electrolyte component may include an anion, also referred to as an “anionic electrolyte component.” For example, the first electrolyte component may include an acid and/or base having one or more anions that are reactive with a metallic component as described herein. Example anions useful according to the present disclosure include SO₄²⁻, OH⁻, Cl⁻, Br, I⁻, O⁻² and combinations thereof. In some non-limiting examples, the first electrolyte component may include NaOH, KOH, HSO₄²⁻, H₂O₂, H₂SO₄, LiOH, LiC1, KC1, LIBr, KBr, ZnBr , Na₂SO₄, Li₂SO₄, ionic liquid electrolyte, organic electrolytes, molten salts ,or a combination thereof.

According to some aspects, the electrolyte of the present disclosure may be a liquid electrolyte. In this example, the liquid electrolyte may include a solvent in which the first electrolyte component is provided as a solute. Example solvents useful according to the present disclosure include, but are not limited to, water, organic solvents, liquid ionic electrolytes, molten salt electrolytes, solid electrolyte, and combinations thereof. In some non-limiting examples, the electrolyte may be an aqueous electrolyte, that is, a liquid electrolyte wherein the solvent is at least 50% v/v water, optionally at least about 90% v/v water, optionally at least about 99% v/v water, and optionally about 100% v/v water. Additionally or alternatively, the first electrolyte component may itself be a solvent or a portion thereof.

The multi-electrode of the present disclosure further includes a second electrode material functionable by a second electrochemical mechanism. That is, the second electrode material of the present disclosure functions in an electrochemical system via a second electrochemical mechanism as described herein. According to some aspects, the second electrochemical mechanism may be described by equation (3):

CB⇄C+N^{y+}+ye− (3)

In equation (3), C is the second electrode material, B is an ionic electrolyte component, and e- are electrons. For example, the second electrode material may include a carbon material, a metal oxide, a polymers conductor, and/or a single-layer material that reacts with an ionic electrolyte component during charge and discharge of an electrochemical system.

In one non-limiting example, the second electrode material may include a carbon material such as graphene. In this example, when the multi-electrode is provided in contact with an intercalating ion in an electrolyte, such as cadmium, the second electrochemical mechanism may include a reaction as shown below as equation (4a):

C₆Cd→C₆Cd²⁺Cd^{2′}2e⁻ (4a)

It should be understood that equation (4a) represents a second discharge mechanism, that is, the second electrochemical mechanism observed upon discharge of an electrochemical system that includes the multi-electrode. In this example, during charge of the electrochemical system, the multi-electrode may be functionable by a second charge mechanism, that is, the second electrochemical mechanism observed upon charge of an electrochemical system that includes the multi-electrode. The second charge mechanism may include a reaction as shown below as equation (4b):

C₆Cd²⁺2e−→C₆Cd (4b)

It should also be understood that the present disclosure is not limited to this example. For example, when the multi-electrode is provided in contact with an intercalating ion such as zinc, the second discharge mechanism may include a reaction as shown in equation (4c):

C₆Zn→C₆+Zn²⁺2e− (4c)

In this example, the second charge mechanism may include a reaction as shown in equation (4d):

C₆Zn²⁺2e−→C₆Zn (4d)

It should also be understood that the present disclosure is not limited to graphene as the second electrode material. For example, the carbon material may include additional or alternative materials, such as carbon fibers, carbon nanostructures, carbon black, nanographites, high surface area graphite, and combinations thereof. As used herein, the term “nanostructure” refers to a structure having at least one dimension on the nanoscale (i.e., between about 0.1 and 100 nm). Example nanostructures include, but are not limited to, nanocages, nanocubes, nanofibers, nanoflowers, nanofoams, nanoparticles, nanospindles, nanoribbons, nanorods, nanosheets, nanospindles, nanotubes, and nanowires. The carbon material may have any shape useful for an electrode material as described herein, including but not limited to amorphous, layered, hierarchical, 2D-structure, 2D-nanostructure, 2D-plateted, 2D-exfoliated, 2D-porous, hollow, vertically aligned, yarns, 3D-porous, 3D-smashed, 3D-sonicated, or a combination thereof.

Additionally or alternatively, the second electrode material may include a transition metal dichalcogenide, a metal oxide, a polymer conductor, or a combination thereof. Example transition metal dichalcogenides include, but are not limited to, MoS₂, WS2, MoSe₂, WSe₂, MoTe₂, and combinations thereof. Example metal oxides include, but are not limited to, TiO₂, ZnO, Fe₂O₃, Nb₂O₃, Co₂O₃, MnO₂, NiO, Al₂O₃, and combinations thereof. Example polymer conductors include, but are not limited to, conducting polymers such as polyanilines, poly(pyrrole)s (PPY), polycarbazoles, polyindoles, poly(fluorene)s, polyphenylenes, polypyrenes, polyazulenes, polynaphthalenes, poly(thiophene)s (PT), poly(3,4-ethylenedioxythiophene) (PEDOT), poly(p-phenylene sulfide) (PPS), and combinations thereof.

Equations (5) shows a non-limiting example of a second discharge mechanism according to the present disclosure when the second electrode material includes TiO₂ as described herein:

TiO₂Cd→TiO₂Cd²⁺+2e− (5)

According to some aspects, the second electrode material may include more than one component such that the second electrochemical mechanism may include a reaction involving each of the more than one component. For example, in the case wherein the second electrode material includes a carbon material and TiO₂, the second discharge mechanism may be shown by equations (6a) and (6b) below.

C₆Cd→C₆+Cd²⁺+2e− (6a)

TiO₂Cd→RiO₂+Cd²⁺2e− (6b)

According to some aspects, the second electrode material may include a single-layer material, also referred to as a 2D-material. A single-layer material refers to a material that includes a single layer of atoms. In some non-limiting examples, the single-layer material may include any material as described herein. Additionally or alternatively, the single-layer material may include a single element material (e.g., graphene, borophene, germanene, silicene, stanine, plumbene, phosphorene, and antimonene), a metal, an alloy, a compound (e.g., graphene, boron nitride nanosheets, titanate nanosheets, borocarbonitrides, MXenes, transition metal dichalcogenide monolayers, 2D-silica, niobium bromide, niobium chloride, and germane), a combined surface alloying material, an organic material, or a combination thereof.

It should be understood that the second electrode material may be selected such that the electrode is configured to be used as a cathode or an anode. As used herein, a “positive electrode” and “cathode” are used synonymously and refer to the electrode having the higher electrode potential in an electrochemical cell (i.e., higher than the negative electrode). “Negative electrode” and “anode” are used synonymously herein and refer to the electrode having the lower electrode potential in an electrochemical cell (i.e., lower than the positive electrode). Cathodic reduction refers to a gain of electron(s) of a chemical species, and anodic oxidation refers to the loss of electron(s) of a chemical species.

In some non-limiting examples, the second electrode material may include carbon, a metal oxide, and a polymer conductor in order to provide a negative electrode. In some non-limiting examples, the second electrode material may include a single-layer material, a metal oxide, and a polymer conductor in order to provide a cathode.

It should be understood that the electrolyte of the present disclose may further include a second electrolyte component that is reactive with the second electrode material as described herein. It should also be understood that in the case of a liquid electrolyte, the second electrolyte may be provided as a solute in a solvent as described herein. That is, the second electrolyte may be provide in a solution wherein the solvent includes water, an organic solvent, the first electrolyte component, or a combination thereof. Additionally or alternatively, the second electrolyte may itself be a solvent or a portion thereof. According to some aspects, the second electrolyte component may include an ionic component, such as an intercalating ion. As used herein, the term “intercalating ion” refers to an ion capable of intercalation, that is, reversible inclusion into a material, particularly the second electrode material as described herein. For example, the second electrolyte component may include a metal capable of providing metallic ions, including, but not limited to, lithium, sodium, zinc, cadmium, potassium, silver, aluminum, platinum, and alloys thereof.

According to some aspects, the second electrochemical mechanism may additionally involve intercalation of intercalating ions of the second electrolyte component into the second electrode material.

The multi-electrode of the present disclosure provides increased electron transfer as compared with an electrode having only the first electrode material or the second electrode material as described herein.

For example, electron transfer of a traditional battery will be governed by a single electrochemical mechanism, such as that of equation (1) or equation (3) as discussed above. By using the multi-electrode of the present disclosure, however, electron transfer will be governed by the first electrochemical mechanism and the second electrochemical mechanism as described herein, which may result in a combined electron transfer as shown in equation (7a):

M+A^{x-}+CB⇄MA+C+B^{y+}+(x+y)e− (7a)

In equation (7a), M is the first electrode material, A is an anionic electrolyte component, C is the second electrode material, B is an ionic electrolyte component, and e- are electrons. It should be understood that the combined electron transfer provided by the multi-electrode may alternatively be as shown in equation (7b), particularly wherein the second electrode material includes more than one component as described herein:

M+A^{x}+NB+SB⇄MA+N+S+2B^{y+}+(x+2y)e− (7b)

In equation (7b), M is the first electrode material, A is an anionic electrolyte component, N is a first component of the second electrode material, S is a second component of the second electrode material, B is an ionic electrolyte component, and e− are electrons.

It should be understood that equations (7a) and (7b) represent the combination of the first electrochemical mechanism and the second electrochemical mechanism by which the multi-electrode functions (alternatively referred to as the combined electrochemical mechanism). It should be further understood that the multi-electrode of the present disclosure may similarly be governed by combined discharge and charge mechanisms upon discharge and charge of an electrochemical system including the multi-electrode, respectively, as described herein.

Equation (8a) shows one illustrative example of a combined discharge mechanism corresponding with a multi-electrode having a carbon material, a lead material, and TiO₂ as electrode materials as described herein:

Pb+SO₄²⁻+C₆Cd+TiO₂Cd→PbSO₄+C₆+2Cd²⁺+TiO₂+6e− (8a)

In this example, electron transfer during charge will be governed by a combined charge mechanism as shown in equation (8b):

PbSO₄+C₆2Cd²⁺TiO₂6e−→Pb+SO₄²⁻+C₆Cd+TiO₂Cd (8b)

According to some aspects, the first and second charge and discharge mechanism may occur concurrently during charge and discharge of an electrochemical system that includes the multi-electrode, respectively. Additionally or alternatively, the first charge and/or discharge mechanism and the second charge and/or discharge mechanism may occur sequentially during charge and/or discharge.

For example, according to some aspects, discharge of an electrochemical system that includes the multi-electrode as described herein may include two or more phases (alternatively referred to as plateaus), wherein each of the two more phases is governed by a discharge mechanism as described herein. In one non-limiting example, discharge of an electrochemical system that includes the multi-electrode may include a first phase governed by a first discharge mechanism and a second phase governed by a second discharge mechanism, wherein the second phase is after the first phase. In this example, charge of the electrochemical system may include a first phase governed by a first charge mechanism and a second phase governed by a second charge mechanism, wherein the second phase is after the first phase.

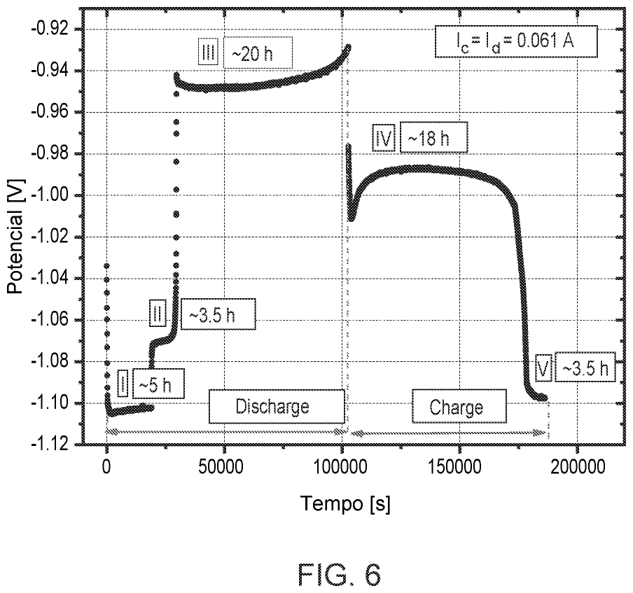

FIG. 6 shows one example discharge and charge process of an electrochemical system having a multi-electrode as described herein. In particular, FIG. 6 shows the example potential behavior during discharge and subsequent charge of a lead-acid battery having a multi-electrode as described herein with a current of 0.061 A between the potentials of −1.10 V and −0.93 V.

In this example, the process includes a first discharge phase (II) of about 3.5 hours that is governed by a first discharge mechanism. For example, in the case wherein the multi-electrode includes graphene as a first electrode material, the first discharge mechanism may be represented by equation (9a):

[C₆Cd→C₆+Cd²⁺2e−]x (9a)

As shown in FIG. 6, the process may further include a second discharge phase (III) of about 20 hours that is governed by a second discharge mechanism. For example, in the case wherein the multi-electrode includes lead as a second electrode material, the second discharge mechanism may be represented by equation (9b):

[Pb+SO₄²⁻→PbSO₄+2e−]y (9b)

In this example, the combined discharge mechanism for the multi-electrode may be represented by equation (9c), wherein x and y depend on potential.

yPb+ySO₄²⁻+xC₆Cd→yPbSO₄xC₆+xCd²⁺+2(x+y)e− (9c)

As shown in FIG. 6, the process may further include first charge phase (IV) of about 18 hours that is governed by a first charge mechanism, which may be represented by equation (9d):

[Pb+SO₄+2e−→Pb+SO₄²⁻]y (9d)

The process may further include a second charge phase (V) of about 3.5 hours that is governed by a second charge mechanism, which may be represented by equation (9e):

[C₆Cd²⁺+2e−→C₆Cd]x (9e)

In this example, the combined charge mechanism for the multi-electrode may be represented by equation (90, wherein x and y depend on potential:

yPbSO₄+xC₆+xCd²⁺+2(x+y)e−→yPb+ySO₄²⁻+xC₆Cd (9f)

It should be understood that FIG. 6 also shows an initial charge phase (I), which may be governed by any one of equations (9d)-(9f).

According to some aspects, the multi-electrode of the present disclosure may include the first electrode material and the second electrode material provided as a composite. The ratio of the first electrode material to second electrode material may be selected to provide a certain specific capacity. In some non-limiting examples, the amount of second electrode material in the multi-electrode may be between about 0.1 and 100% m/m of the first electrode material, optionally between about 0.1 and 50% m/m, optionally between about 0.1 and 25% m/m, optionally between about 0.1 and 10% m/m, and optionally between about 0.1 and 5% m/m. In some non-limiting examples wherein the second electrode materials includes more than one component, each of the two or more second electrode material components may be between about 0.1 and 100% m/m of the first electrode material, optionally between about 0.1 and 50% m/m, optionally between about 0.1 and 25% m/m, optionally between about 0.1 and 10% m/m, optionally between about 0.1 and 5% m/m, and optionally between about 0.1 and 1% m/m.

The composite of the present disclosure may be provided by any method known in the art and useful according to the present disclosure, including sonication, mixing, polymerization, selective laser sintering techniques, pyrolysis, sol-gel processes, electrodeposition, or a combination thereof. According to some aspects, at least a portion of the first electrode material and/or the second electrode material may serve as a matrix for at least a different portion of the first electrode material and/or the second electrode material.

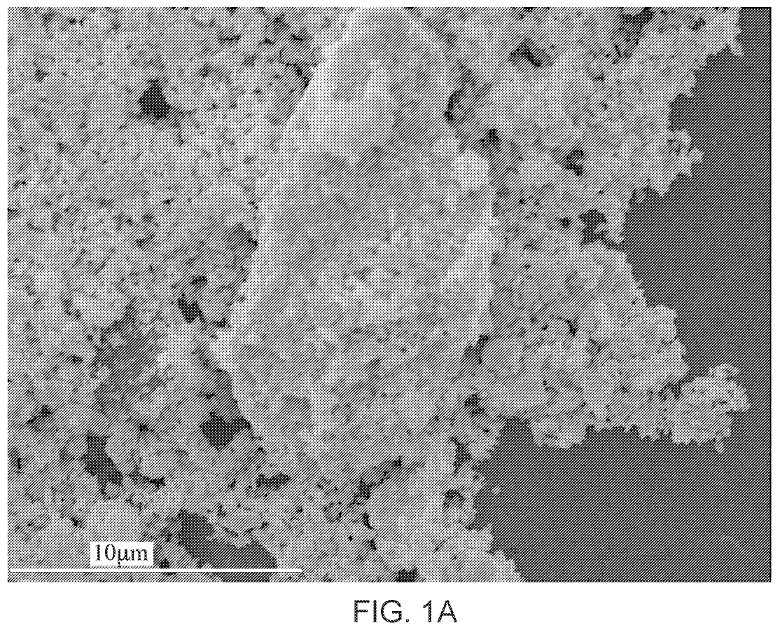

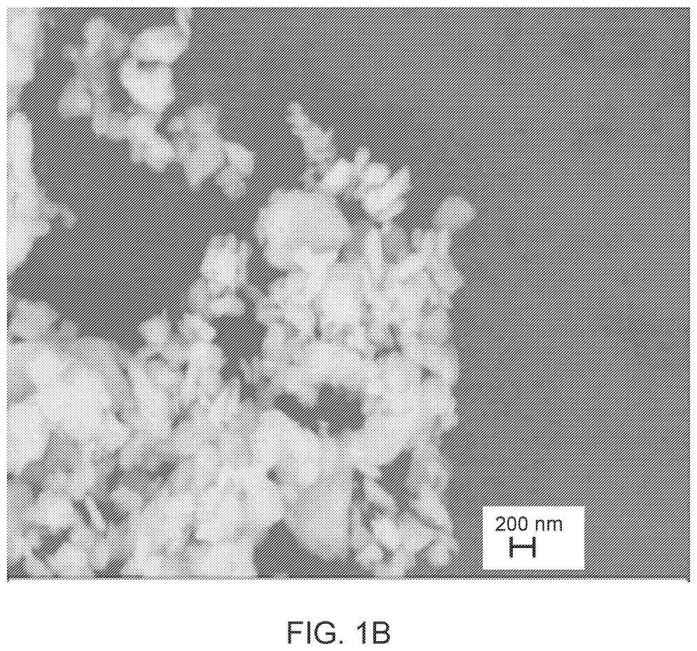

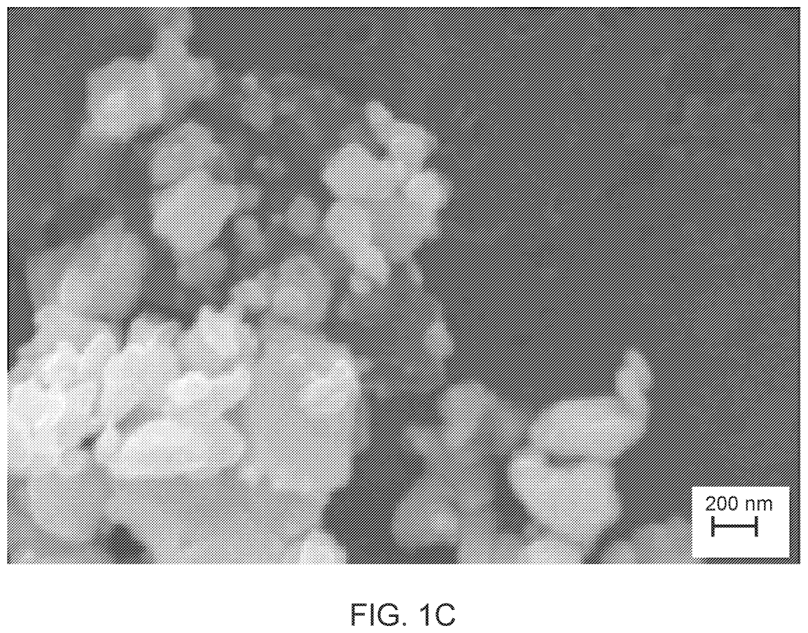

In one non-limiting example, the composite of the present disclosure may be provided by a physical-chemical high-energy production method that generates chemical and electrical bonding between the first electrode material and the second electrode material. For example, the production method may include simultaneously sonicating a first electrode material and a second electrode material. FIG. 1A shows an electron microscopy image of one non-limiting example of such a composite. In particular, FIG. 1A shows graphene as a second electrode material on which nanoparticles of a first electrode material, PbO, are decorated. In this example, the first electrode material nanoparticles may be provided to the second electrode material matrix via simultaneous sonication of first electrode material and the second electrode material.

FIGS. 1B and 1C show additional electron microscopy image of the Pb0 decorated graphene as shown in FIG. 1A.

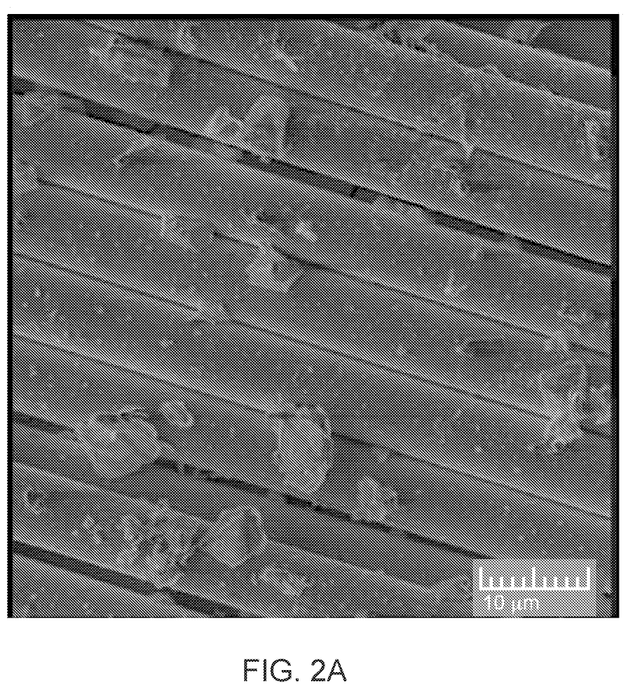

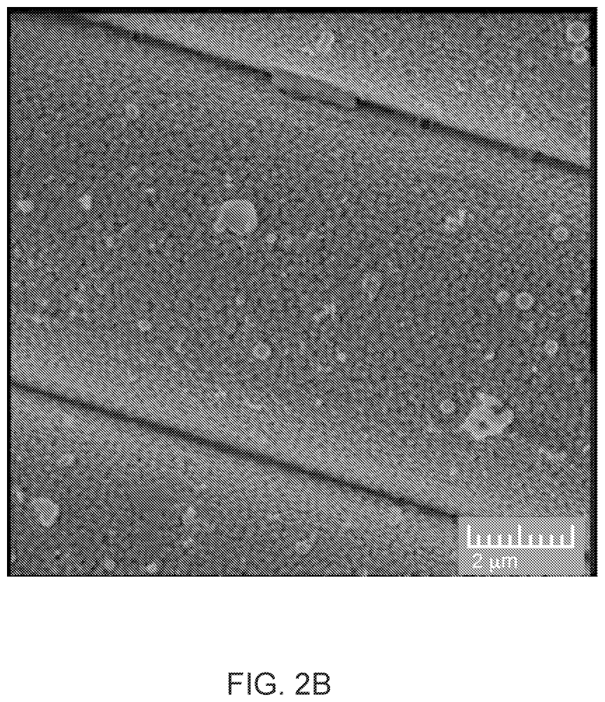

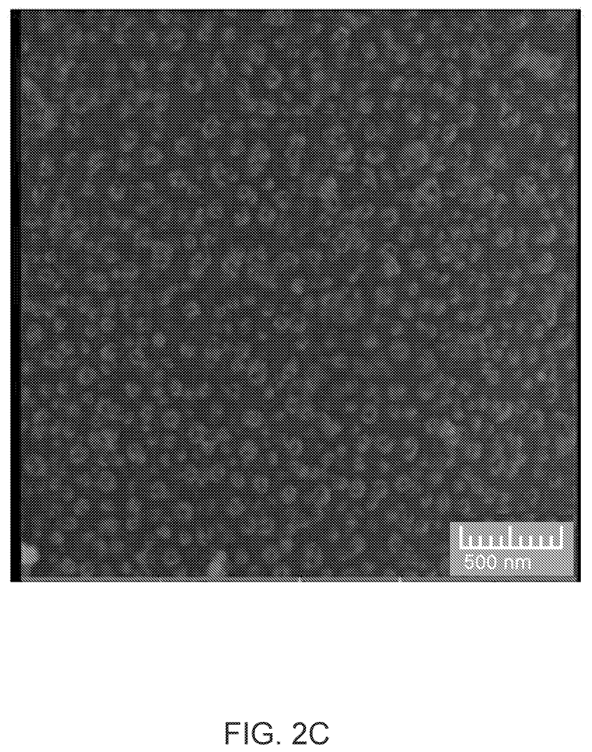

In another non-limiting example, the composite of the present disclosure may be provided by electrodepositing one of the first electrode material and the second electrode material on a surface of the other of the first electrode material or the second electrode material. FIG. 2A shows an electron microscopy image of one non-limiting example of such a composite. In particular, FIG. 2A shows a carbon fiber as a second electrode material on which nanoparticles of a first electrode material, Pb0, are decorated. In this example, the first electrode material nanoparticles may be provided on a surface of the second electrode material matrix via electrodeposition.

FIGS. 2B and 2C show additional electron microscopy image of the carbon fibers having PbO nanoparticles electrodeposited thereon as shown in FIG. 2A.

It should be understood that the multi-electrodes of the present disclosure provide several benefits over conventional electrodes, including fast recharging of regenerative brakes, increased power and energy, long service life to avoid electrode deaths due to partial charge and overload charge in energy storage battery systems, and/or life cycle extension of electric mobility batteries, avoiding electrolyte loss.

The present disclosure is also directed to an electrochemical system having at least one multi-electrode as described herein. The electrochemical system may include at least one multi-electrode and an electrolyte having a first electrolyte component and a second electrolyte component as described herein. The electrochemical system may further include a second electrode that is the same as or different from the multi-electrode as described herein. The electrochemical systems of the present disclosure may include lead-acid batteries, nickel cadmium batteries, nickel iron batteries, metal-air batteries, or a combination thereof.

The present disclosure is also directed to methods of making the multi-electrodes as described herein. The method may include providing a first electrode material and a second electrode material such that at least a portion of the first electrode material and/or the second electrode material serves as a matrix for at least a different portion of the first electrode material and/or the second electrode material.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Herein, the recitation of numerical ranges by endpoints (e.g. between about 50:1 and 1:1, between about 100 and 500° C., between about 1 minute and 60 minutes) include all numbers subsumed within that range, for example, between about 1 minute and 60 minutes includes 21, 22, 23, and 24 minutes as endpoints within the specified range. Thus, for example, ranges 22-36, 25-32, 23-29, etc. are also ranges with endpoints subsumed within the range 1-60 depending on the starting materials used, temperature, specific applications, specific embodiments, or limitations of the claims if needed. The Examples and methods disclosed herein demonstrate the recited ranges subsume every point within the ranges because different synthetic products result from changing one or more reaction parameters. Further, the Examples and methods disclosed herein describe various aspects of the disclosed ranges and the effects if the ranges are changed individually or in combination with other recited ranges.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

As used herein, the terms “about” and “approximately” are defined to being close to as understood by one of ordinary skill in the art. In one non-limiting embodiment, the terms “about” and “approximately” are defined to be within 10%, preferably within 5%, more preferably within 1%, and most preferably within 0.5%.

The examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

### EXAMPLES

### EXAMPLE I: Comparison of Multi-Electrode and Conventional Electrode Capacitance

The specific capacity (Ah·g⁻¹) of a conventional lead electrode was compared with that of a multi-electrode having a composite of lead, cadmium, and graphene as described herein. In order to perform the study, the multi-electrode was input into the center of an electrochemical cell with two counter electrodes with high specific areas and a cadmium reference electrode. Cathodic current was applied to the multi-electrode until totally charged and anodic current, I₂₀ (for discharge C20), to discharge until the cut-off potential of 0.3 Volt. Specific capacity was calculated using the equation Q=I*t/m, wherein I is applied current, t is time in seconds, and m is the mass of active material in the multi-electrode.

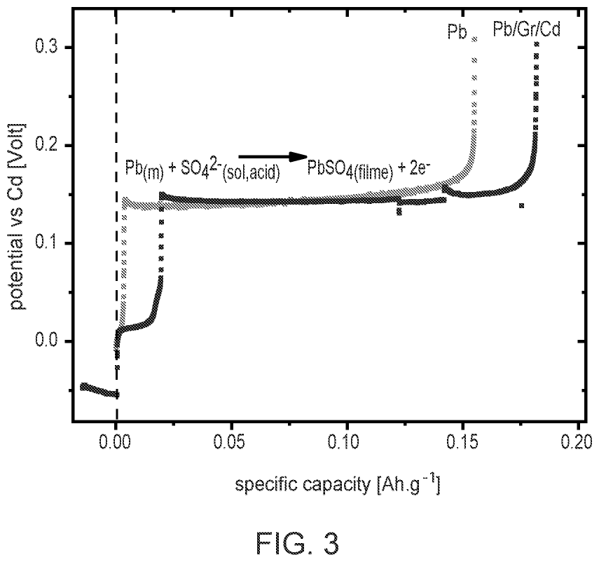

FIG. 3 shows a plot overlaying the specific capacity of the conventional lead electrode and the multi-electrode. Surprisingly, the multi-electrode showed significantly improved capacitance.

### EXAMPLE II: Comparison of Multi-Electrode and Conventional Electrode Charge/Discharge

The charge/discharge time of a conventional lead electrode was compared with that of a multi-electrode having a composite of lead, cadmium, and graphene as described herein. In order to perform the study, the multi-electrode was input into the center of an electrochemical cell with two counter electrodes with high specific areas and a cadmium reference electrode. Cathodic current was applied to the multi electrode until totally charged and anodic current, I₂₀ (for discharge C20), to discharge twice until the cut-off potential of 0.15 Volt and finally 0.3 Volt.

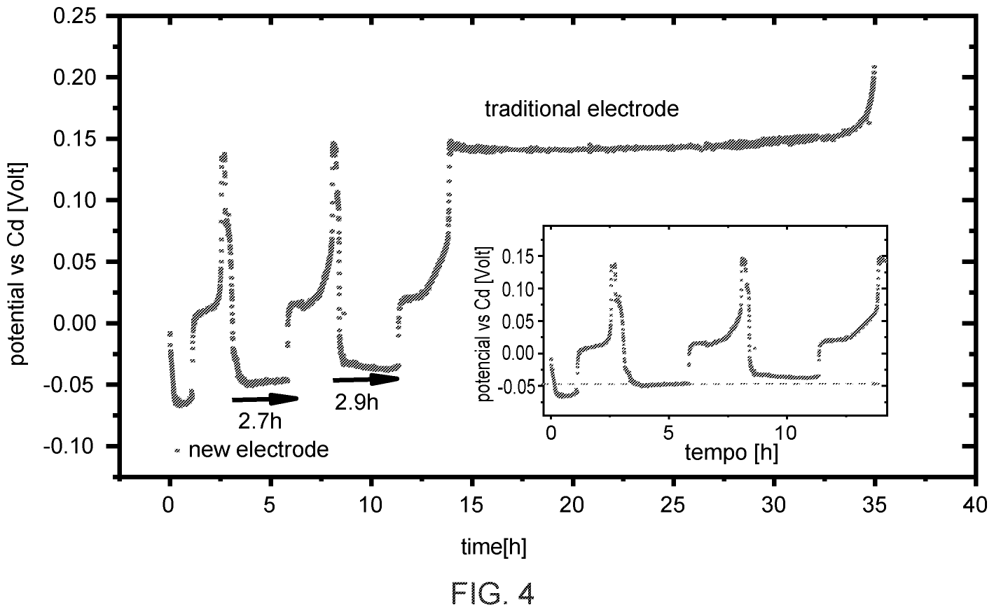

FIG. 4 shows a battery cycling curve for the conventional lead electrode and the multi-electrode. Surprisingly, the multi-electrode showed stability in cycling.

### EXAMPLE III: Comparison of Multi-Electrode and Conventional Electrode Capacitance

The specific capacity (Ah·g⁻¹) of a conventional lead electrode was compared with that of a multi-electrode having a composite of lead, TiO₂, and graphene as described herein. In order to perform the study, the multi-electrode was input into the center of electrochemical cell with two counter electrodes with high specific areas and a cadmium reference electrode. Cathodic current was applied to the multi electrode until totally charged and anodic current, I₂₀ (for discharge C20), to discharge until the cut-off potential of 0.3 Volt. Specific capacity was calculated using the equation Q=I*t/m, wherein I is applied current, t is time in seconds, and m is the mass of active material in the multi-electrode.

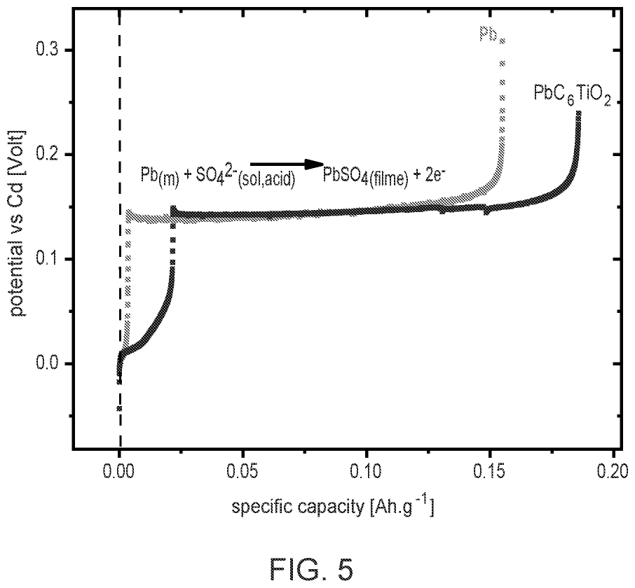

FIG. 5 shows a plot overlaying the specific capacity of the conventional lead electrode and the multi-electrode. Surprisingly, the multi-electrode showed significantly improved capacitance.

### EXAMPLE IV(a): Preparation of TiO₂@Gr Composite

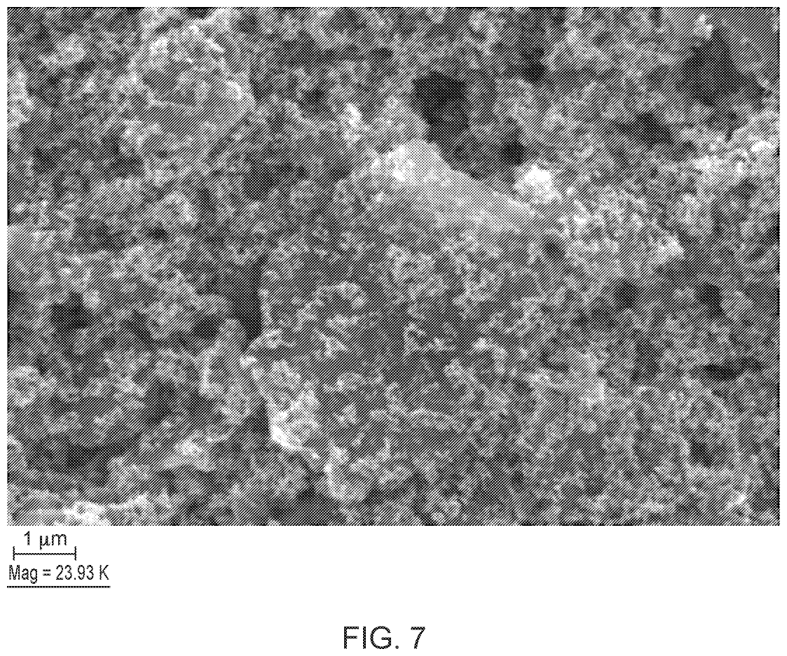

First, a TiO₂@Gr nanocomposite was produced through a high-energy physical-chemical method, resulting in the arrangement of TiO₂ particles on graphene sheets. This generated a composite having properties that are a combination of the characteristics of its constituent components, transforming, in this specific case, TiO2 nanoparticles from insulators into electrical conductors. FIG. 7 shows a scanning electron microscopy (SEM) image of the TiO₂@Gr composite. In FIG. 7, black particles represent graphene, and white particles represent TiO₂ type P25.

### EXAMPLE IV(b): Preparation of TiO₂@Gr Multi-Electrode

First, a paint was formed by combining the TiO₂@Gr composite prepared according to Example IV(a), polyethylene (PEG) 1500 as a binder, Triton X-100 (24442,4,4-trimethylpentan-2-yl)phenoxylethanol) as a surfactant, and ethanol as a solvent. The paint was then provided on the surface of an FTO (fluorine-doped tin oxide) glass substrate and cured on a thermal ramp up to 600° C. It should be understood that in this example, the negative electrode is carbon, which is the most common negative electrode in batteries that operate through ion intercalation mechanisms with metallic ions (Li⁺, Na⁺, Zn²⁺, Cd⁺, etc.). The development of the TiO₂@Gr nanocomposite on the FTO substrate is an example method for producing a multi-electrode applied to carbon, specifically the graphene electrode. In this example, instead of adding an intercalation electrode to the metallic one, as in the lead-acid battery, the titanium metal electrode is added to the intercalation electrode, which in this case is carbon

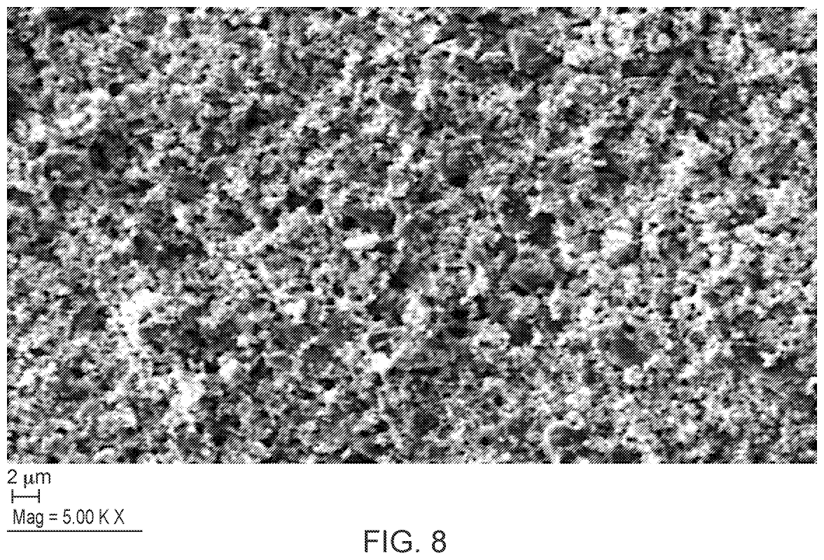

FIG. 8 shows an SEM image of the resulting TiO₂@Gr multi-electrode on the FTO substrate, the FTO substrate forming a current collector that does not react during the charge and discharge of the TiO₂@Gr multi-electrode.

### EXAMPLE IV(c): Cycling of TiO₂@Gr Multi-Electrode with Cd²⁺Electrolyte

The multi-electrode prepared according to Example IV(c) was provided as part of an electrochemical system having an aqueous H₂SO₄ solution containing Cd²⁺ ions as a liquid electrolyte, a cadmium reference electrode, and a PbO₂ counter electrode. Both the reference electrode and the counter electrode had current density of 20 mA·cm⁻².

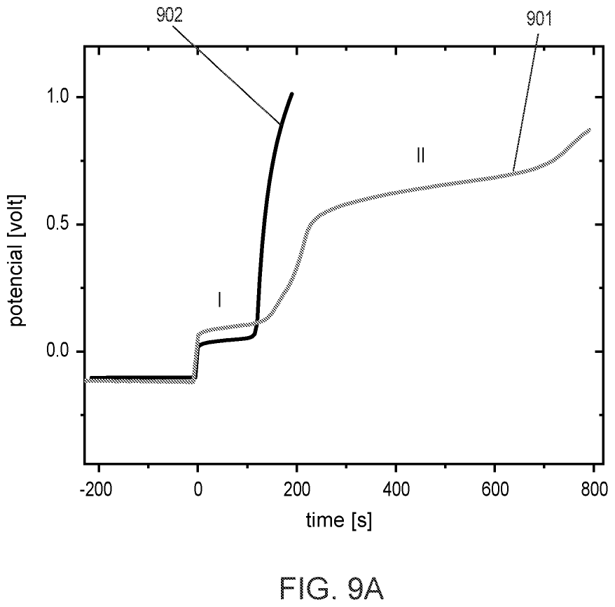

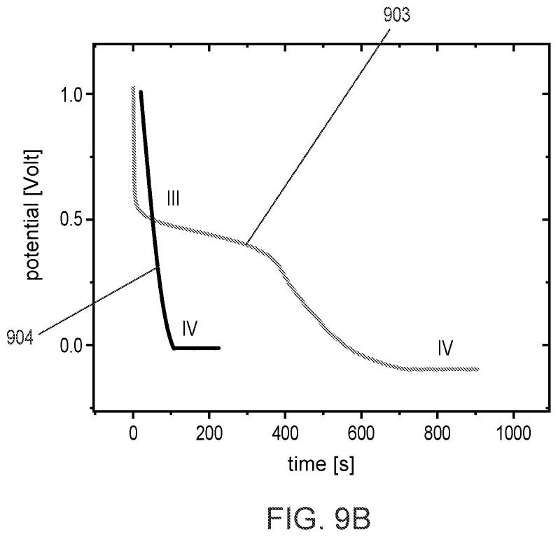

FIG. 9A shows the discharge behavior of the electrochemical system with galvanostatic measurements within the defined potential limits. As shown in FIG. 9A, the discharge process included a first discharge phase (I) that was governed by a first discharge mechanism as shown in equation (10a):

[C₆Cd→C₆+Cd⁺²+2e−]x (10a)

The discharge process further included a second discharge phase (II) that was governed by a second discharge mechanism as shown in equation (10b):

[Ti+H₂O→TiO+2H⁺+2e−]y (10b)

It was determined that the combined discharge mechanism for the multi-electrode may be represented by equation (10c), wherein x and y depend on potential:

xC₆Cd+yTi+yH₂O→xC₆+xCd⁺²+xTiO+2yH⁺+2(x+y)e− (10c)

In addition to the discharge process corresponding to the multi-electrode (i.e., line 901), FIG. 9A also shows the discharge process corresponding to a graphite electrode (i.e., line 902), as known in the art. That is, FIG. 9A compares the electrochemical behavior of a single carbon electrode, i.e., a graphite rod, and the TiO₂@Gr multi-electrode as described. Line 902 corresponds with the discharge of a carbon electrode, where only one galvanostatic plateau corresponding to equation (10a) is observed. Line 901 represents the discharge of the multi-electrode with two plateaus corresponding to equations (10a) and (10b).

FIG. 9B shows the charge process of the same electrochemical system. As shown, the charge process included a first charge phase (III) that was governed by a first charge mechanism as shown in equation (10d):

[TiO+2H⁺+2e−→Ti+H₂O]y (10d)

The charge process further included a second charge phase (IV) that was governed by a second charge mechanism as shown in equation (10e):

[C₆+Cd⁺²+2e−→C₆Cd]x (10e)

It was determined that the combined charge mechanism for the multi-electrode may be represented by equation (10f), wherein x and y depend on potential:

xC₆+xCd⁺²+xTiO+2yH⁺+2(x+y)e−→xC₆Cd+yTi+yH₂O (10f)

Similar to FIG. 9A, FIG. 9B shows the charge process corresponding to the multi-electrode (i.e., line 903) and the charge process corresponding to a graphite electrode (i.e., line 904) as known in the art. In particular, line 904 corresponds with the charge of a carbon electrode, where only one galvanostatic plateau corresponding with equation (10e) is observed. Line 903 represents the charge of the multi-electrode with two plateaus corresponding to equations (10d) and (10e).

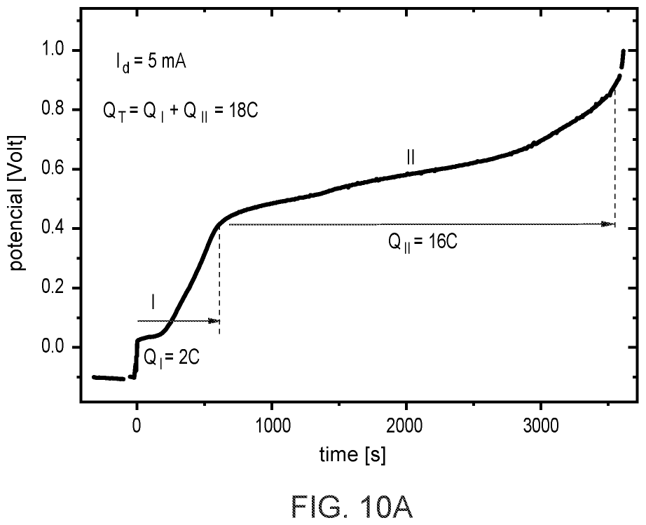

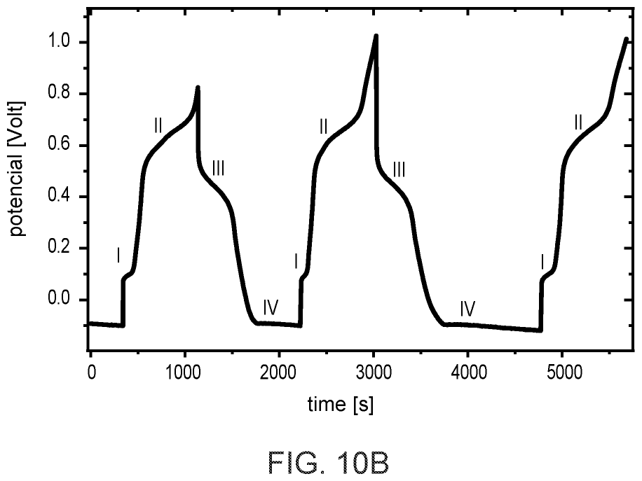

FIG. 10A shows the galvanostatic discharge of the multi-electrode, and FIG. 10B shows the cycling charge and discharge of the multi-electrode. It was determined that the multi-electrode significantly increased the charge per gram as compared with a carbon anode by at least 100%. Notably, due to the considerably larger electrochemical active area of the titanium particles contained by the multi-electrode, the specific capacity was significantly increased. Further, the electrochemical processes during charge and discharge were observed as being invertible, which resulted in cycling with at least a degree of reproducibility.

EXAMPLE IV(d): Cycling of TiO₂@Gr Multi-Electrode with Zn²⁺ Electrolyte

The multi-electrode prepared according to Example IV(c) was provided as part of an electrochemical system having an aqueous H₂SO₄ solution containing Zn²⁺ ions as a liquid electrolyte, a cadmium reference electrode, and a PbO₂ counter electrode. Both the reference electrode and the counter electrode had current density of 20 mA·cm⁻².

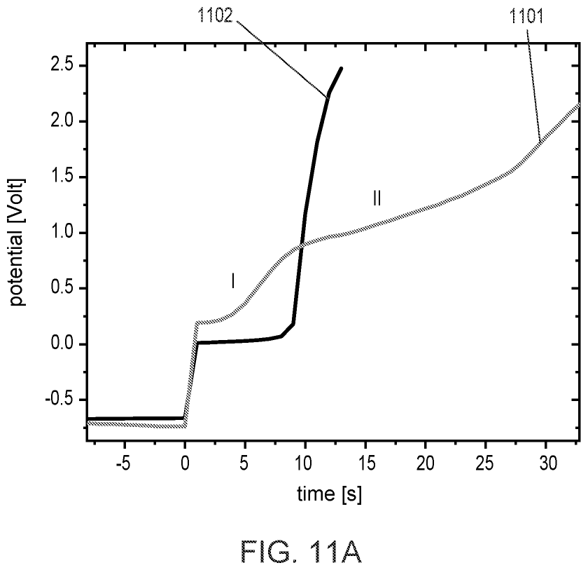

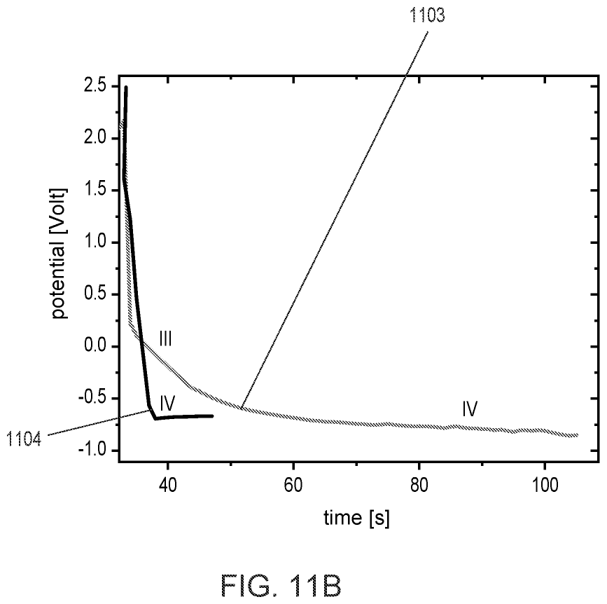

FIG. 11A shows the charge behavior of the electrochemical system with galvanostatic measurements within the defined potential limits. As shown in FIG. 11A, the discharge process included a first discharge phase (I) that was governed by a first discharge mechanism as shown in equation (11a):

[C₆Zn →C₆+Zn⁺² +2e−]x (11a)

The discharge process further included a second discharge phase (II) that was governed by a second discharge mechanism as shown in equation (11b):

[Ti+H₂O→TiO+2H⁺+2e−]y (11b)

It was determined that the combined discharge mechanism for the multi-electrode may be represented by equation (11c), wherein x and y depend on potential:

xC₆Zn+yTi+yH₂O→xC₆+xZn⁺+xTiO+2yH⁺+2(x+y)e− (10c)

In addition to the discharge process corresponding to the multi-electrode (i.e., line 1101), FIG. 11A also shows the discharge process corresponding to a graphite electrode (i.e., line 1102), as known in the art. Specifically, FIG. 11A compares the electrochemical behavior of a single carbon electrode, i.e., graphite rod, and the TiO2@Gr multi-electrode as described. Line 1102 corresponds with the discharge of a carbon electrode, where only one galvanostatic plateau corresponding to equation (11a) is observed. Line 1101 represents the discharge of the multi-electrode with two plateaus corresponding to equations (11a) and (11b).

FIG. 11B shows the charge process of the same electrochemical system.

As shown, the charge process included a first charge phase (III) that was governed by a first charge mechanism as shown in equation (11d):

[TiO+2H⁺+2e−→Ti+H₂O]y (11d)

The charge process further included a second charge phase (IV) that was governed by a second charge mechanism as shown in equation (11e):

[C₆+Zn⁺²+2e−→C₆Zn]x (11e)

It was determined that the combined charge mechanism for the multi-electrode may be represented by equation (110, wherein x and y depend on potential:

xC₆+xZn⁺²+xTiO+2yH⁺+2(x+y)e−→xC₆Zn+yTi+yH₂O (10f)

Similar to FIG. 11A, FIG. 11B shows the charge process corresponding to the multi-electrode (i.e., line 1103) and the charge process corresponding to a graphite electrode (i.e., line 1104) as known in the art. In particular, line 1104 corresponds with the charge of a carbon electrode, where only one galvanostatic plateau corresponding to equation (11e) is observed. Line 1103 represents the charge of the multi-electrode with two plateaus corresponding to equations (11d) and (11e).

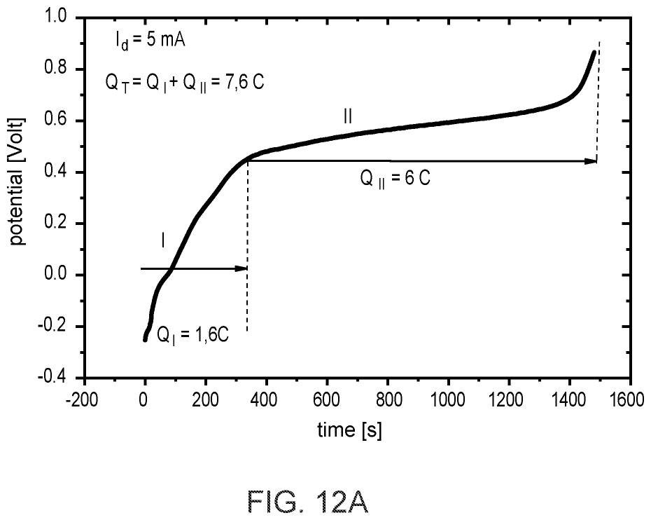

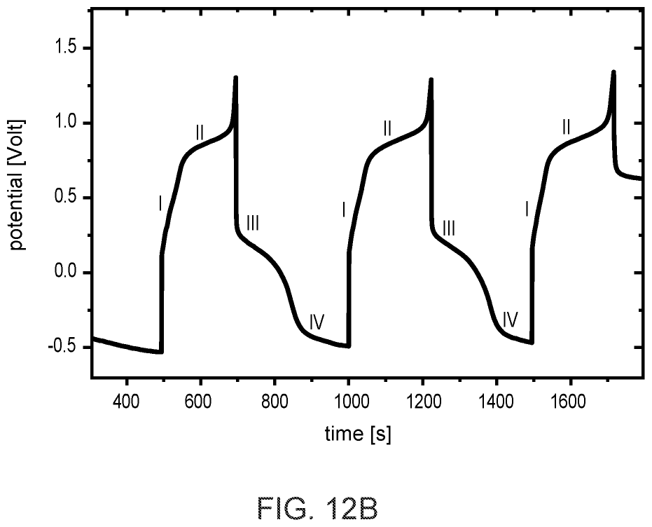

FIG. 12A shows the galvanostatic discharge of the multi-electrode, and FIG. 12B shows the cycling charge and discharge of the multi-electrode. It was determined that the multi-electrode significantly increased the charge per gram as compared with a carbon anode by at least 100%. Notably, due to the considerably larger electrochemical active area of the titanium particles contained by the multi-electrode, the specific capacity was significantly increased. Further, the electrochemical processes during charge and discharge were observed as being invertible, which resulted in cycling with at least a degree of reproducibility.

### EXAMPLE V(a): Production of Lead-Acid Electrochemical System

First, a multi-electrode plate having a PbO@Gr nanocomposite was provided as a negative plate. The multi-electrode plate was then centered between two positive plates as counter electrodes, the positive plates being commercial lead-acid battery plates having the same width and length as the multi-electrode plate. The resulting three-plate structure was provided in communication with an aqueous sulfuric acid electrolyte having Cd²⁺ ions in order to provide a lead-acid electrochemical system.

### EXAMPLE V(b): Determination of the Potential Behavior as a Function of Time

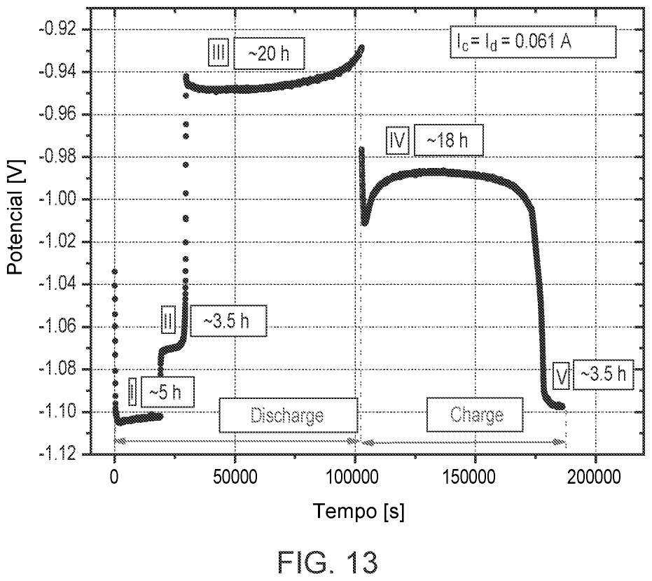

An initial capacity measurement of the electrochemical system of Example V(a) was taken with a current of 0.061 A between potentials of −1.10 V and −0.93 V, measured against a mercury sulphate Hg/Hg₂SO₄ reference electrode. FIG. 13 shows the behavior of the voltage as a function of time during the execution of this cycle. In FIG. 13, five plateaus can be observed, including two discharge plateaus (plateaus II and III at potential values of approximately −1.07 V and −0.95 V) and two charge plateaus (plateaus IV and V at potential values of approximately −0.99 V and −1.10 V). Plateau I is the same as plateau V.

It was determined that if plateau III, with a duration of approximately 20 hours, is considered equivalent to the discharge plateau of a negative plate in a traditional lead-acid battery, then the current of 0.061 A would be the 20-hour discharge current (120). The capacity of plateau III (i.e., the charge related to this plateau) is approximately 1.22 Ah.

### EXAMPLE V(c): Charge and Discharge Measurements for Partially Charged Plates with a Current of 1.000 A

Several charge and discharge measurements were generated using an electrochemical system as described in Example V(a) in two states of charge: fully charged (plate loaded to 100%) and partially charged, which as achieved by fully charging the negative plate then discharging for 5.5 hours with the same current used in the initial capacity measurement (0.061 A). These measurements were performed in two independent electrochemical systems. Considering that each plate contains 0.24 g of the composite, the current was determined to correspond with approximately 4.17 A/g of composite.

To generate the first set of measurements, each electrochemical system was initially brought to the partially charge state. Then, with the electrochemical systems in this state, ten cycles of charge and discharge were performed with a constant current of 1.000 A, finalizing the discharges at a potential of −0.93 V and the charges at a potential of −1.230 V for the plate of the first electrochemical system and at −1.28 V for the plate of the second electrochemical system.

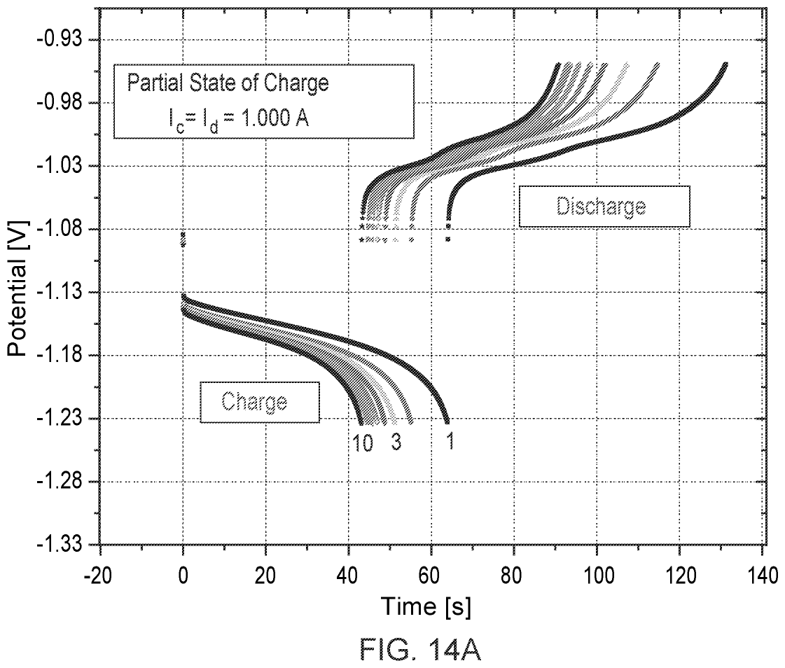

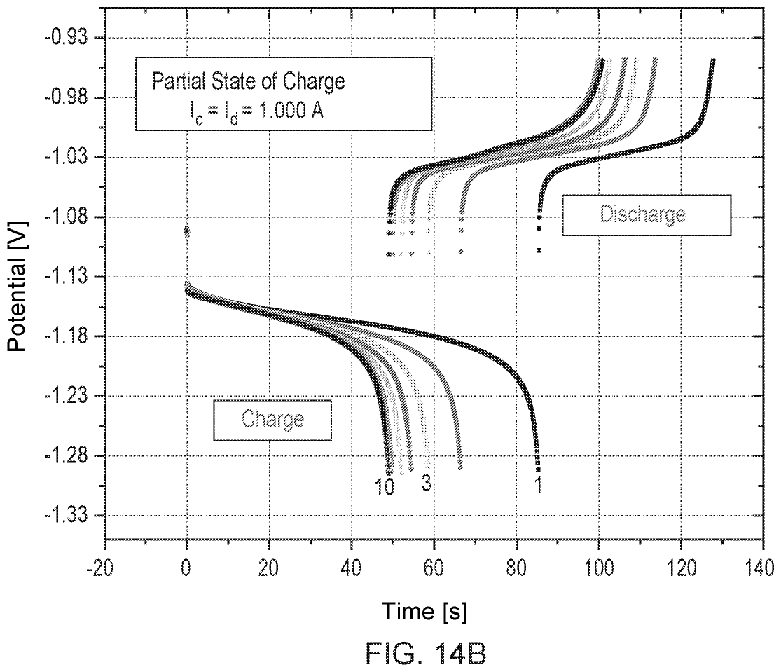

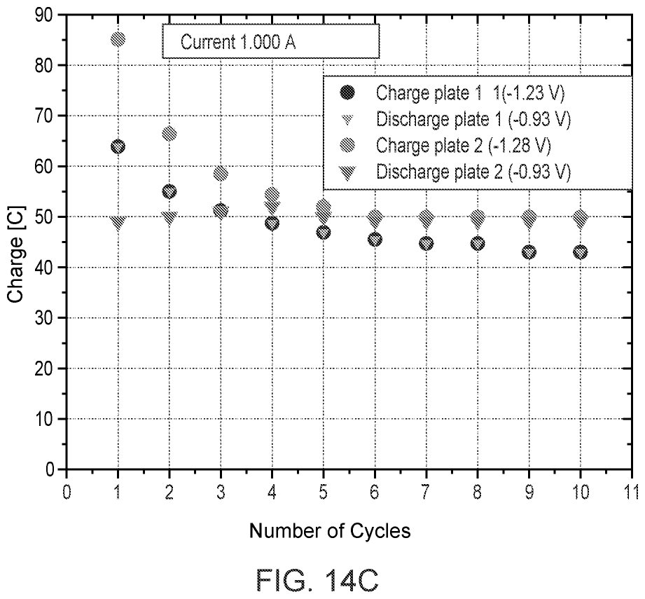

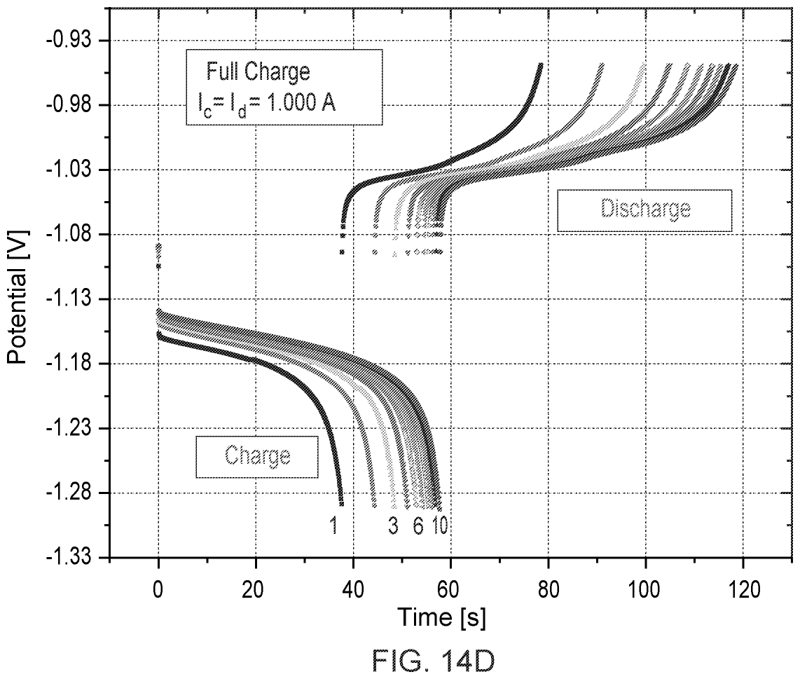

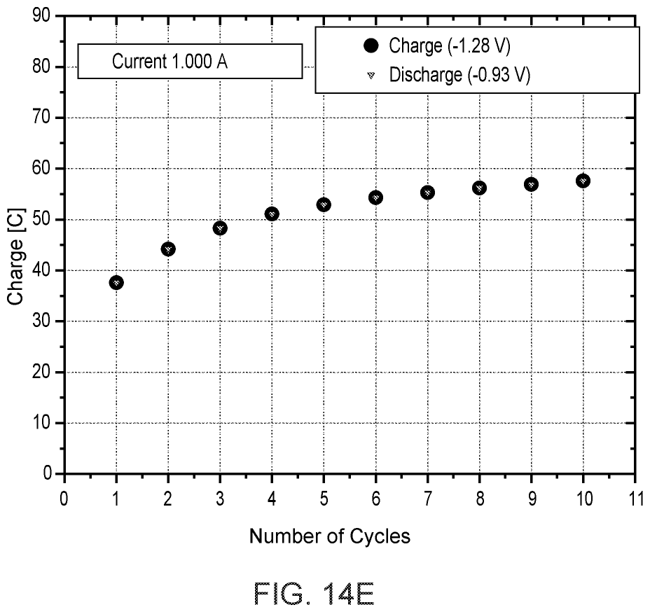

FIG. 14A shows the potential behavior for each of the ten charge and discharge cycles performed on the partially charged negative plate of the first electrochemical system, with a current of 1.000 A between potentials of −0.93 V and −1.230 V with respect to the reference electrode. FIG. 14B shows the potential for each of the ten charge and discharge cycles performed on the partially charged negative plate of the second electrochemical system, with a current of 1.000 A between potentials of −0.93 V and −1.280 V with respect to the reference electrode.

As shown in FIGS. 14A, the partially state, which was reached with a discharge of 5.5 hours with a current of 0.061 A, corresponds approximately with a discharge that discharges all of plateau II and reaches 10% of plateau III, considering that the discharge starts from the beginning of plateau II.

As shown in FIGS. 14A and 14B, stabilization of the potential behavior (and the charges involved in the plateaus) occurs between approximately five and six cycles.

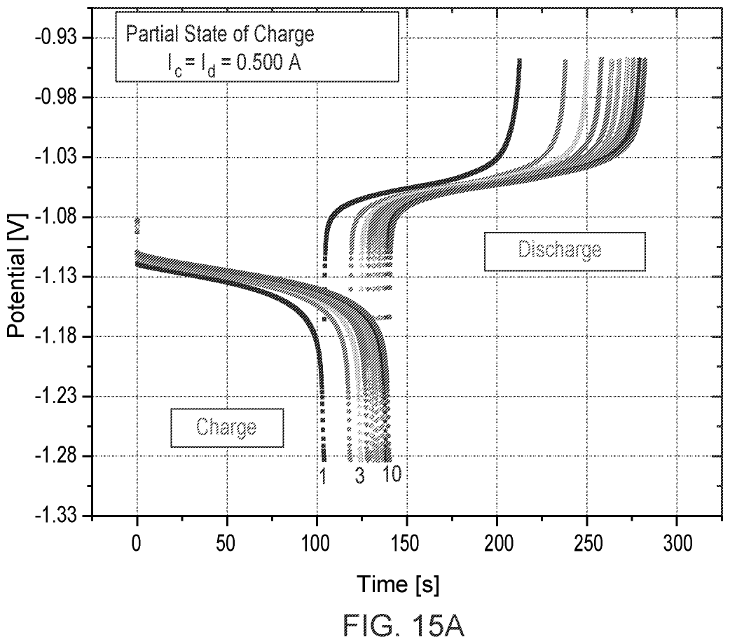

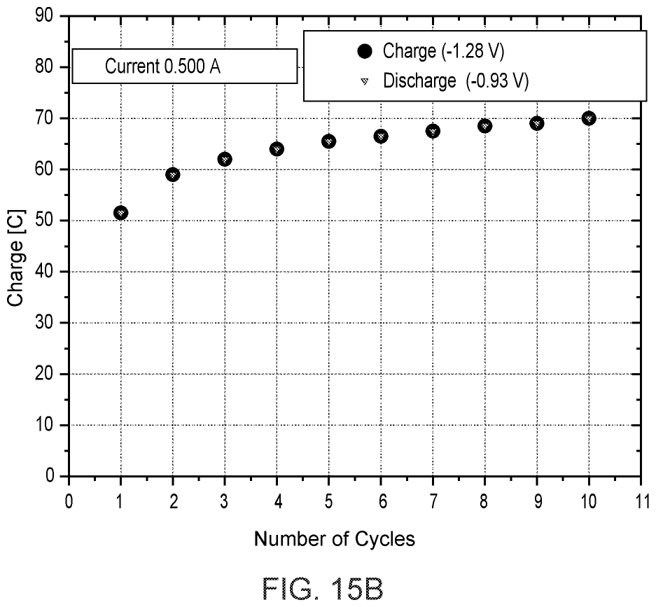

FIG. 14C shows the behavior of the charges involved in each of the plateaus described in FIGS. 14A and 15B over the ten cycles performed. As shown ins FIG. 14C, in the case of the negative plate of the first electrochemical system (which was charged to a potential of −1.23 V), the charges corresponding with the charge and discharge plateau for each cycle practically coincide (superimposed in the figure). On the other hand, in the case of the negative plate of the second electrochemical system (charged to a potential of −1.28 V), the charge during discharge remained practically constant, but the charge corresponding with the charging process decreased until stabilizing at approximately 50 Coulombs (C) after five or six cycles.

The process was then repeated using fully charged plates. In particular, ten charge and discharge cycles were performed with a constant current of 1.000 A, finishing the discharges at a potential of −0.93 V and the charges at a potential of −1.28 V. FIG. 14D shows the potential behavior as a function of time for each of the ten cycles performed.

Comparing FIG. 14D with FIGS. 14A and 14B, it was determined that there was a reversal in the potential behavior over the cycles. In the case of FIG. 14D, the duration of the plateau increases with the number of cycles, whereas in FIGS. 14A and 14B, it decreases.

The behavior of the charges over the ten cycles performed can be seen in FIG. 14E. As shown in this figure, the charges corresponding with the charging and discharging plateau for each cycle practically coincide (overlapped in the figure) and tend toward a value close to 60 C over the cycles.

### EXAMPLE V(d): Charge and Discharge Measurements for Partially Charged Plates with a Current of 0.500 A

In this example, charge and discharge measurements were generated with an electrochemical system as described in Example V(a) in a partially charged state as described in relation to Example V(c). Considering that each plate contains 0.24 g of the composite, the current was determined to correspond with approximately 2.08 A/g of composite.

First, ten cycles of charge and discharge were executed with a constant current of 0.500 A, with discharges ending at a potential of 0.93 V and charges ending at a potential of −1.28 V. FIG. 15A shows the potential as a function of time for each of the ten cycles.

As shown in FIG. 15A, the stabilization of charges during the cycles followed the same behavior as in Example V(c). As shown, the duration of the plateaus of charge and discharge increases with the number of cycles. This behavior can be observed in FIG. 15B, where the charges of these plateaus are represented as a function of the cycle number over the first ten cycles executed. The charges corresponding with the charge and discharge plateau for each cycle practically coincide (they overlap in FIG. 15B) and tend toward a value close to 70 C over the cycles.

### EXAMPLE V(e): Charge and Discharge Measurements for Partially Charged Plates with a Current of 1.500 A

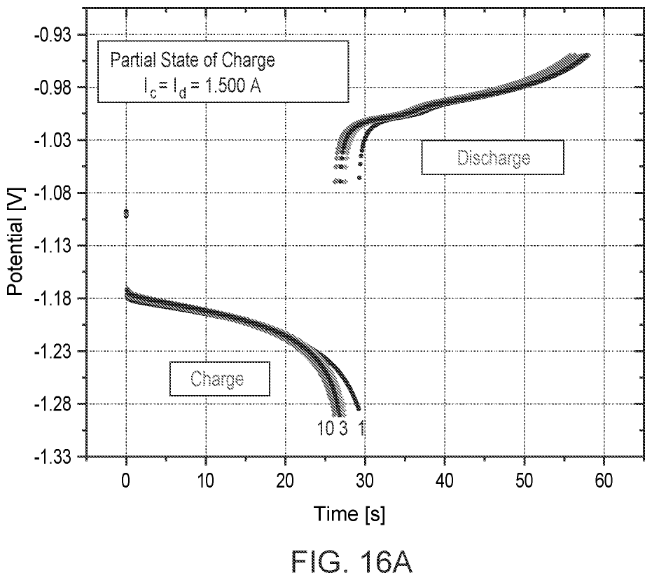

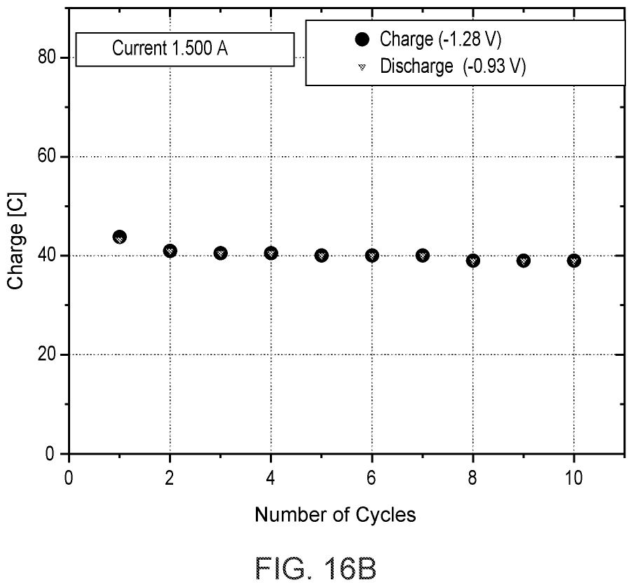

In this example, charge and discharge measurements were generated with an electrochemical system as described in Example V(a) in a partially charged state as described in relation to Example V(c). Considering that each plate contains 0.24 g of the composite, the current was determined to correspond with approximately 6.25 A/g of composite. Ten cycles of charge and discharge were executed with a constant current of 1.500 A, with discharges ending at a potential of −0.93 V and charges ending at a potential of −1.28 V. FIG. 16A shows the potential behavior over time for each of the ten cycles performed. As shown, a stabilization trend of the plateau behavior can be observed after a few cycles.

FIG. 16B shows the values of the charges associated with each plateau of the first ten cycles. Here, unlike the previous examples, the trend toward stabilization was in the direction of a decrease in the charges involved in the plateaus, trending toward a value close to 40

C.

EXAMPLE V(f): Charge and Discharge Measurements for Partially Charged Plates with a Current of 2.000 A

In this example, charge and discharge measurements were generated with an electrochemical system as described in Example V(a) in a partially charged state as described in relation to Example V(c). Considering that each plate contains 0.24 g of the composite, the current was determined to correspond with approximately 8.33 A/g of composite. Ten cycles of charge and discharge were executed with a constant current of 2.000 A, with discharges ending at a potential of −0.93 V and charges ending at a potential of −1.28 V.

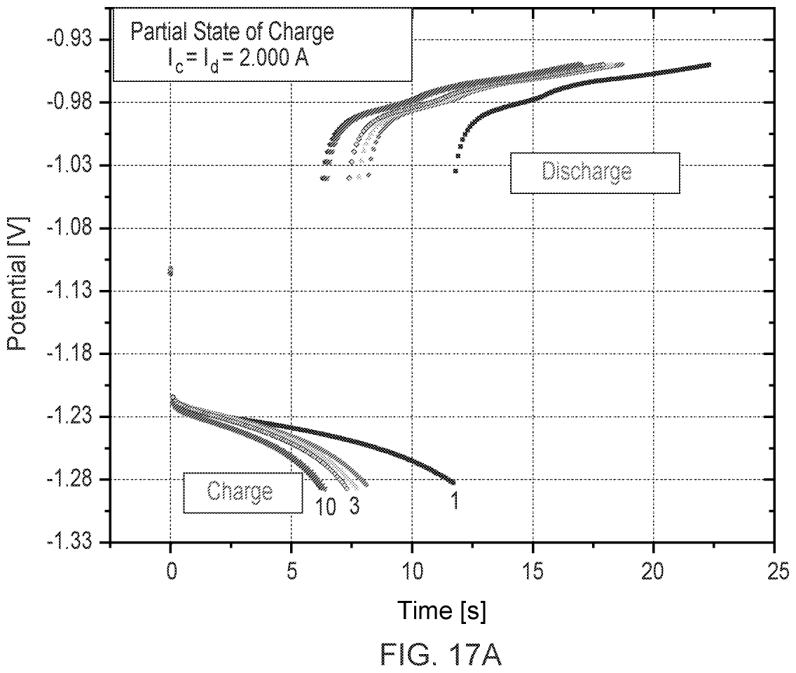

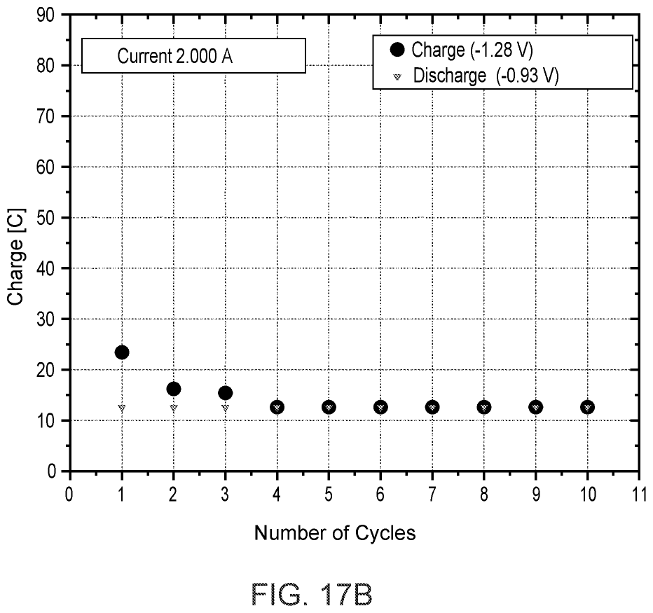

FIG. 17A 11 shows the potential behavior as a function of time for each of the ten cycles performed. Again, there is a tendency towards stabilization in the behavior of the plateaus after the fifth cycle. FIG. 17B shows the behavior of the loads involved in each plateau as a function of the number of cycles. For the current of 2.000 A, the stabilization of the charge occurs close to the value of 12 C.

EXAMPLE V(g): Conclusions

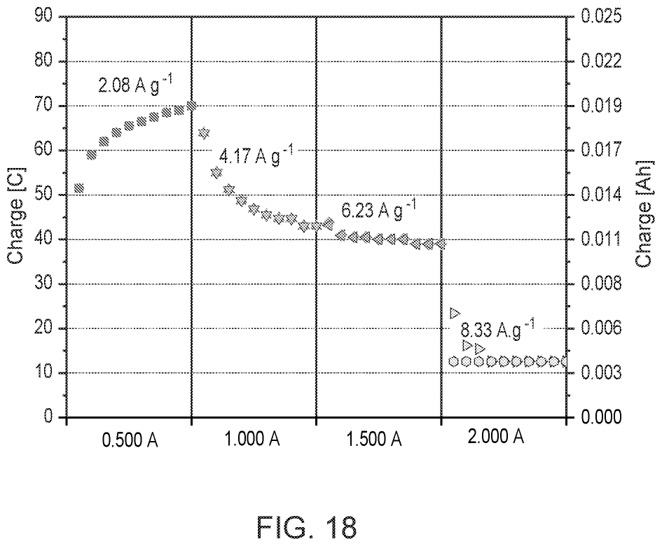

FIG. 18 shows results obtained from the charge and discharge procedures as described in Examples V(c)-(f). (In the case of Example V(c), where two electrochemical systems were studied, the charges for the first electrochemical system are shown.) FIG. 18 also shows the corresponding values of the currents per gram of the composite material.

From Examples V(c)-(f), it was determined that the charges involved in the charge and discharge procedures practically coincide after a few stabilization cycles (between three and five cycles). This was observed in all cases, for all tested current values, from 0.500 A to 2.000 A. This suggests that there are no significant parallel reactions (i.e., all the charge provided in the charging procedure is effectively assimilated by the battery and recovered in the following discharge).

Regarding the reproducibility of the results, FIG. 14C shows results obtained with two different negative plates, where one stabilized at the level of 50 C and the other at approximately 45 C.

Regarding reproducibility, comparing the measurements made with different currents, in all cases, the results show a reproducible behavior in which the plates tended to stabilize after a few cycles in a situation where the charges (from the discharge and subsequent charging procedures) were equal.

What is claimed is:

1. A multi-electrode comprising:
a first electrode material; and
a second electrode material,
wherein the first electrode material is functionable by a first electrochemical mechanism, and
wherein the second electrode material is functionable by a second electrochemical mechanism that is different from the first electrochemical mechanism.

2. The multi-electrode of claim 1, wherein the first electrode material comprises a metallic material, a metal oxide material, or a combination thereof.

3. The multi-electrode of claim 1, wherein the second electrode material comprises a carbon material, a metal oxide, a single layer material, a polymer conductor, or a combination thereof.

4. The multi-electrode of claim 3, wherein the second electrode comprises a first component and a second component.

5. The multi-electrode of claim 4, wherein the first component comprises the carbon material and the second component comprises the metal oxide.

6. The multi-electrode of claim 1, wherein the first electrode material and the second electrode material are provided as a composite.

7. The multi-electrode of claim 6, wherein the second electrode material serves as a matrix for the first electrode material.

8. The multi-electrode of claim 1, wherein the first electrochemical mechanism comprises:
M+A^{x-}⇄MA+xe−
wherein M is the first electrode material, A is an anionic electrolyte component, and e− are electrons.

9. The multi-electrode of claim 1, wherein the second electrochemical mechanism comprises:
CB⇄C+B^{y+}+ye−
wherein C is the second electrode material, B is an ionic electrolyte component, and e− are electrons.

10. The multi-electrode of claim 1, wherein electron transfer of the multi-electrode is governed by equation:
M+A^{x-}+CB⇄MA+C+B^{y+}+(x+y)e−
wherein M is the first electrode material, A is an anionic electrolyte component, C is the second electrode material, B is an ionic electrolyte component, and e− are electrons.

11. An electrochemical system comprising:
a multi-electrode, wherein the multi-electrode comprises:
a first electrode material, and
a second electrode material,
wherein the first electrode material is functionable by a first electrochemical mechanism, and
wherein the second electrode material is functionable by a second electrochemical mechanism that is different from the first electrochemical mechanism; and
an electrolyte, wherein the electrolyte comprises:
a first electrolyte component reactive with the first electrode material, and
a second electrolyte component reactive with the second electrode material.

12. The electrochemical system of claim 11, wherein the first electrode material comprises a metallic material.

13. The electrochemical system of claim 11, wherein the second electrode material comprises a carbon material, a metal oxide, a single layer material, a polymer conductor, or a combination thereof.

14. The electrochemical system of claim 13, wherein the second electrode material comprises a first component and a second component.

15. The electrochemical system of claim 14, wherein the first component comprises the carbon material and the second component comprises the metal oxide.

16. The electrochemical system of claim 11, wherein the first electrolyte component comprises an anionic electrolyte component.

17. The electrochemical system of claim 16, wherein the first electrochemical mechanism comprises:
M+A^{x-}⇄MA+xe−
wherein M is the first electrode material, A is the anionic electrolyte component, and e− are electrons.

18. The electrochemical system of claim 11, wherein the second electrolyte component comprises an intercalating ion.

19. The electrochemical system of claim 18, wherein the second electrochemical mechanism comprises:
CB⇄C+B^{y+}+ye−
wherein C is the second electrode material, B is the intercalating ion, and e- are electrons.

20. The electrochemical system of claim 11, wherein electron transfer of the multi-electrode is governed by equation:
M+A^{x-}+CB⇄MA+C+B^{y+}+(x+y)e−
wherein M is the first electrode material, A is an anionic electrolyte component, C is the second electrode material, B is an ionic electrolyte component, and e- are electrons.
